(19) United States
(12) Patent Application Publication
(10) Pub. No.: US 2006/0202084 A1
(43) Pub. Date: Sep. 14, 2006

(54) Under floor housing system for aircraft passenger entertainment and communications systems

(76) Inventor: George R. Smallhorn, Montreal (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/073,678

(22) Filed: Mar. 8, 2005

(51) Int. Cl. B64D 11/00

(52) U.S. Cl. 244/118.5

(57) ABSTRACT

A floor for an aircraft cabin, made of a removable floor panel having an opening and fasteners for removably mounting to flanges of transverse floor beams and longitudinal floor joists, with a channel formed by a pair of support brackets having: an upper wall mounted to an underside of the floor panel adjacent the opening; side walls; and a bottom wall, the floor having cover mounting tabs extending from the upper walls into the opening; and an access cover removably mounted on the tabs.

### TECHNICAL FIELD

The invention relates to a remote seat cluster in an under floor housing to provide passenger entertainment, voice and data communication, seat actuation and electric power supply for passenger operated devices.

### BACKGROUND OF THE ART

As described in the applicant's U.S. Pat. No. 6,585,189, an increasingly important component of passenger aircraft cabin services is the provision of individualized audio/video entertainment systems, voice and data communications, and electric power for operating laptop computers and personal entertainment devices. Passengers are normally required to remain seated for extended periods and for optimum safety, the passengers should remain seated with safety belt fastened during a flight. To improve service, airlines provide various passenger operated services such as audio and video entertainment, telephone, intercom, television, video games, internet access, email and electrical power supply for laptop computers and personal electronic devices, and especially in business class and first class areas advanced controls for seat positioning and seat comfort controls.

The airlines have responded to passenger's expectations and attempted to improve passenger service by providing seat controls, entertainment and communication services in existing aircraft by retrofitting equipment and in specifying such service capacity in new aircraft as they are purchased. Due to the confines of existing aircraft cabins and seating arrangements, it has been considered necessary to fit passenger seat units with entertainment and communication system electrical boxes or other passenger systems electrical boxes that are currently mounted to the seat legs under the seat.

The conventional location of these bulky digital system electrical boxes in the under seat hand luggage area has several disadvantages, that are addressed by the under floor housing and raceway system described in the applicant's U.S. Pat. No. 6,585,189. The installation of electrical equipment in an under floor housing reduces the risk of injury and potential electrical shock, as well as exposure of the electrical equipment to potential accidental impact damage, vandalism, foreign matter ingestion into cooling fans and spilled beverages served within the passenger cabin. The housing of electrical boxes under floor provides a less cluttered cabin and the flat floor design does not interfere with cleaning of the passenger cabin nor expose electronic units to potential damage from vacuum cleaners and cleaning solvents used during the cleaning of carpets and passenger seats.

The prior art provides for spaced apart under floor air cooled housings with cable raceways between housings and passenger seats but does not provide sufficient flexibility to adapt for future modifications, equipment overhaul or major upgrades. The existing under-floor housing and cable routing systems are less than optimal in terms of ability to adapt for future modifications rapidly, high overall cost, bulk, adequacy of cooling and ease of initial installation, retrofitting, service upgrades and maintenance.

There is a need to rationalize the configuration of passenger service electronics within the passenger cabin, reduce the size, complexity, electric power and cooling demands and to safely stow any electrical components in an isolated environment away from passenger contact that may cause accidental or intentional damage.

Due to stringent aircraft safety requirements it is preferable to provide integrated adequate temperate sensing, temperature controls and cooling for the electronic passenger seat service components, as well as emergency fire suppression capacity.

Further for commercial success, it is preferable to minimize the expense and down time required to modify existing aircraft equipment without requiring extensive modification to the aircraft or requiring the aircraft to be out of service for extended periods of time.

Further issues of concern will be apparent from review of the disclosure, drawings and description of the invention below.

### DISCLOSURE OF THE INVENTION

The invention provides a floor for an aircraft cabin, made of a removable floor panel having an opening and fasteners for removably mounting to flanges of transverse floor beams and longitudinal floor joists, with a channel formed by a pair of support brackets having: an upper wall mounted to an underside of the floor panel adjacent the opening; side walls; and a bottom wall, the floor having cover mounting tabs extending from the upper walls into the opening; and an access cover removably mounted on the tabs.

The invention further provides an elongate channel for housing electronic equipment under the floor of an aircraft cabin, the floor having removable floor panels mounted with fasteners to flanges of transverse floor beams and longitudinal floor joists, the channel having a pair of support brackets having: an upper wall adapted for hanging from one said floor panel adjacent an opening therethrough; side walls; and a bottom wall; a number of cover mounting tabs extending from the upper walls into the opening; and an access cover removably mounted on the tabs.

It is advantageous to integrate passenger seat services, audio, video, electric power, voice and data communication electronics and conduits into under floor compartments and raceways preferably suspended from removable floor panels of the passenger cabin floor to avoid any modification of the primary aircraft structure such as transverse floor beams and longitudinal floor joists with seat tracks. Any modifications to the floor beams and joists even minor changes such as drilling small holes for fasteners, may trigger the requirement for aircraft regulatory approval and inspection. However, floor panels are already mounted to the beams and joists with removable bolts and the floor panels are not generally considered as a structural member requiring regulatory approval when modifications are made. Further, It is possible to pre-fabricate standard floor panels with modification prior to installation in the aircraft. Eliminating any modification to the primary aircraft structure makes installation much easier and faster reducing the downtime required, and returning the aircraft to full service much quicker. By modifying only the floor panels, the system can be pre-fabricated and when the aircraft is brought in for modification, the process merely involves removing existing floor panels by removing fasteners, and reattaching new floor panels with the same fasteners.

### DESCRIPTION OF THE DRAWINGS

In order that the invention may be readily understood, embodiments of the invention are illustrated by way of example in the accompanying drawings.

FIG. 1 shows a side view of a typical passenger aircraft exterior to orient the following sectional views.

FIG. 2 shows a top plan view of the aircraft exterior for the same reason.

FIG. 3 shows a sectional view along line 3-3 of FIG. 2 indicating the orientation of the passenger cabin floor and a typical wide body seating arrangement.

FIG. 4 is a sectional view along line 4-4 of FIG. 1 showing the passenger cabin floor plan and seating arrangement typically found in a wide body aircraft, and showing the location of under floor recessed elongate channel for housing electronic passenger entertainment and communications units and associated cables accessible from the passenger cabin through removable access covers in the cabin floor.

FIG. 5 is a sectional detail view along the line 3-3 showing the channel suspended from the underside of a floor panel.

FIG. 6 is a plan view along line 6-6 of FIG. 5.

FIG. 7 is a sectional view along line 7-7 of FIG. 6.

FIG. 8 is a sectional view along line 8-8 of FIG. 6 showing the operation of the latches in a closed position (solid lines) and an open position (phantom lines).

FIG. 9 is a sectional view similar FIG. 5 showing an optional cooling system for the channel including a blower, an air distribution duct and plenum.

FIG. 10 is a sectional view along line 10-10 of FIG. 9.

FIG. 11 is a plan schematic view of the cooling air distribution system including two air blowers, an elongate air distribution duct, and a plurality of branch lines feeding air to a like plurality of cooling air plenums spaced apart longitudinally along the length of the channel.

Further details of the invention and its advantages will be apparent from the detailed description included below.

### DETAILED DESCRIPTION OF PREFERRED EMBODIMENTS

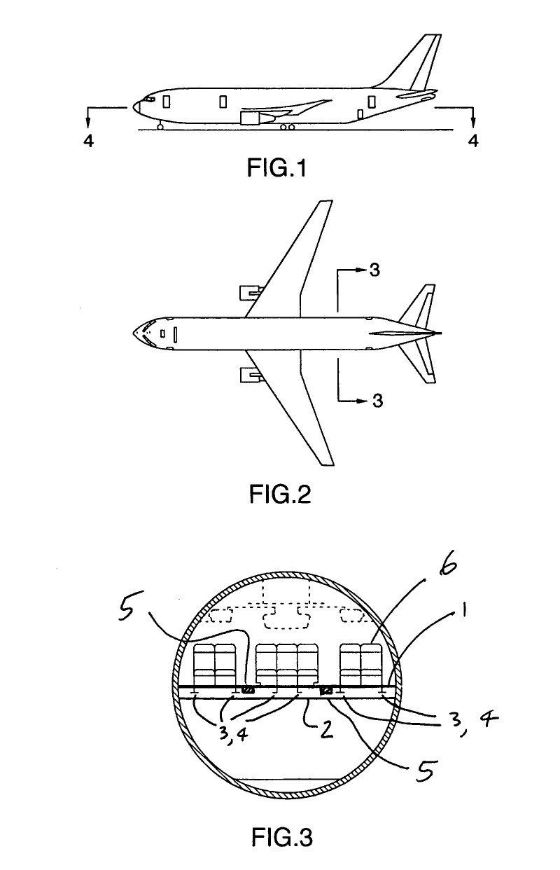

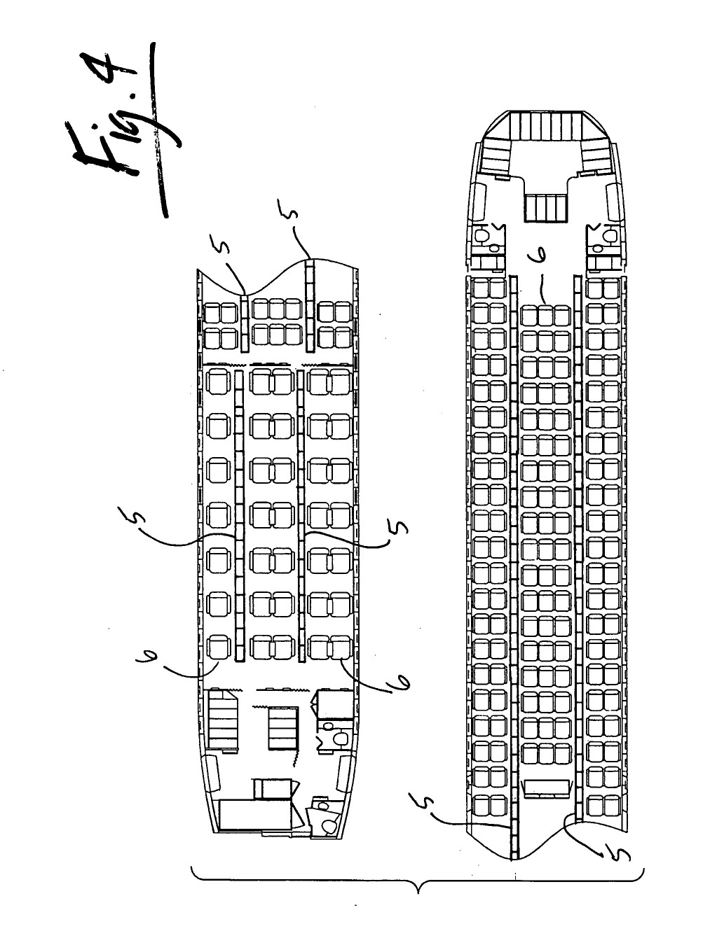

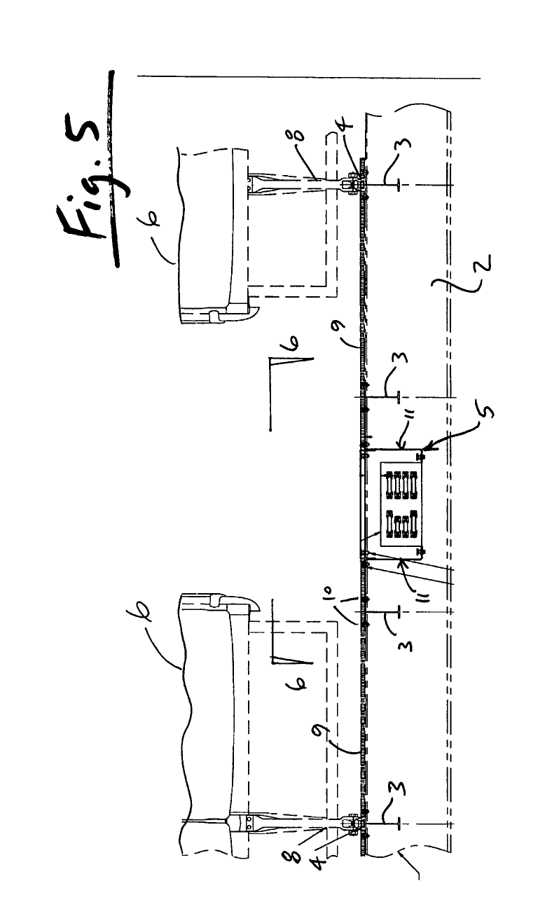

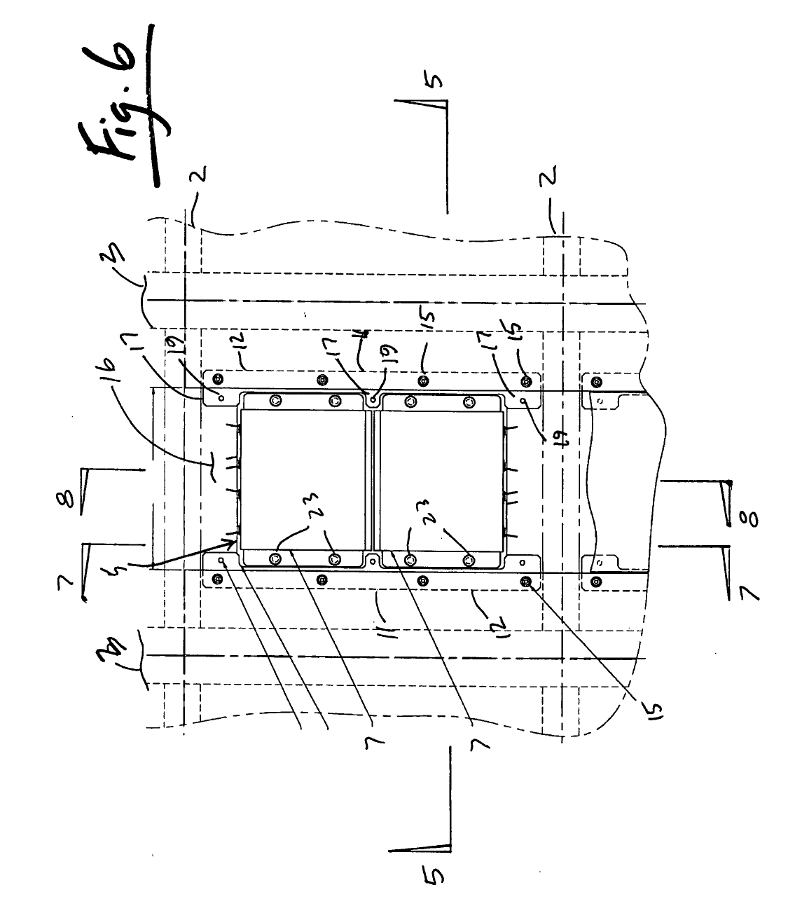

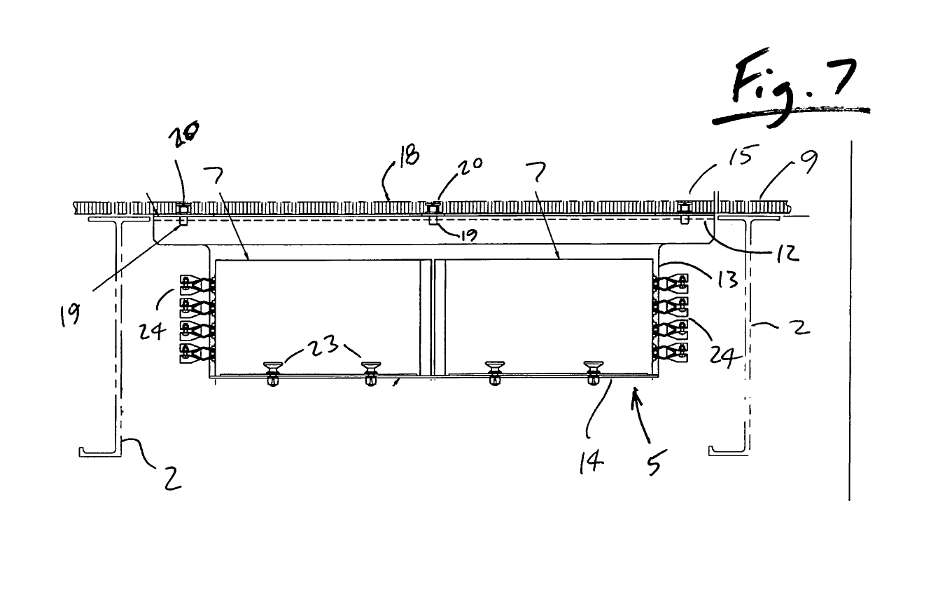

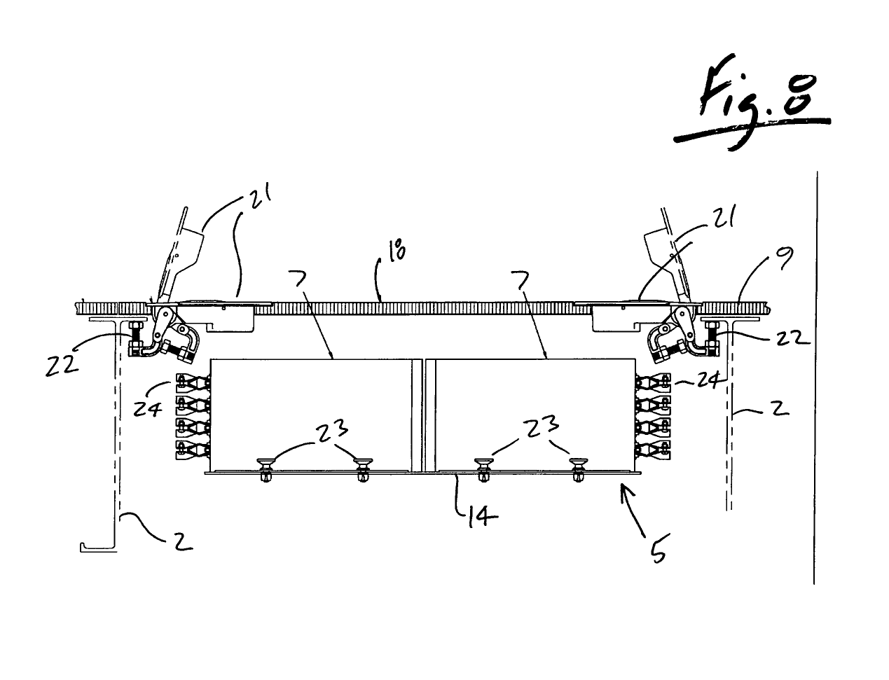

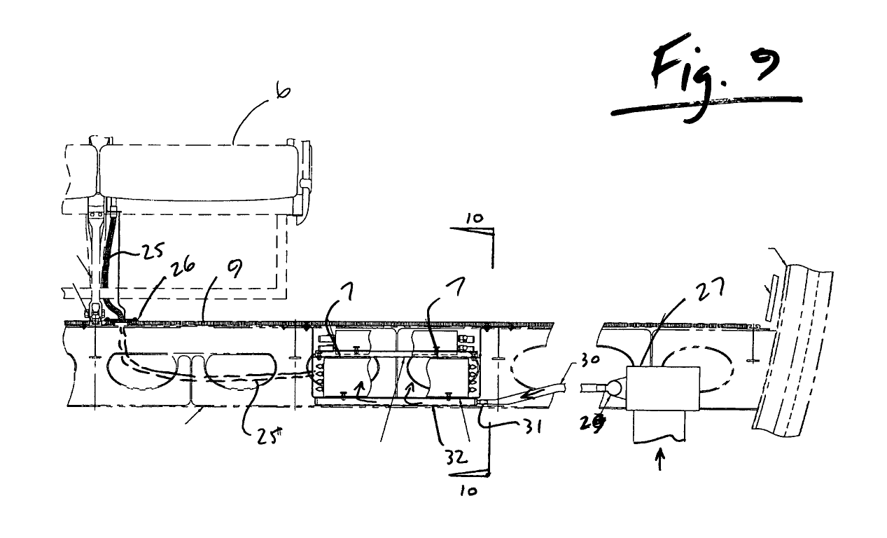

As mentioned above, FIGS. 1 and 2 are provided to orient the reader in quickly understanding the orientation of sectional view FIG. 3 and the floor plan of FIG. 4. A conventional aircraft passenger cabin floor 1, as indicated in FIG. 3, is supported on transverse floor beams 2 that span across the oval aircraft frames and the beams 2 in turn support longitudinal floor joists 3. Floor beams 2 and joists 3 have co-planar top flanges that serve to support the cabin floor panels and where required floor joists 3 have seat tracks 4 in their top flanges projecting through the floor surface to attach seat legs that can slide longitudinally and lock the seats 6 in various seat spacing or pitch patterns as desired. FIG. 3 also indicates the location of the longitudinal under floor channels 5 suspended from the floor panels and accessed through a removable access cover.

FIG. 4 shows a floor plan of a conventional wide body aircraft with different seat arrangements in the forward first class/business class forward portion and closer seat pitch in the rearward economy class area. It will be understood that the seating arrangement shown is an example only and the invention is capable of adaptation to other seating arrangements. The example shown has two aisles with two channels 5, however one channel may be used with laterally extending cable harnesses to serve the each row of seats 6. The usual location of a channel 5 is in an aisle since easy access through removable access panels in the floor is advantageous. Depending on where the floor panel seams are located, the location of the access panels can be modified as required. The channels 5 permit storage of electronic equipment at many locations along their length and serve as cable raceways for associated electric conductors. Optionally, forced air cooling may be provided at locations along the length of the channels 5. In existing aircraft with existing individual passenger seat electronic units, such units can be relocated into the channels 5 after removal from their conventional locations under the seats 6. In newly built aircraft, the channels 5 can be provided as a cabin design option and can be installed with the cabin floor panels to accommodate the aircraft purchasers specified cabin equipment.

As indicated in FIGS. 3 and 4, the elongate channel 5 may extend the full length of the aircraft passenger cabin, may extend a length necessary to serve a portion only, such as the business class portion, or may extend a relatively short distance to serve only selected seats as desired, for example during a trial period or as a special passenger service. Gradual upgrading of an aircraft can progress methodically through the cabin when the aircraft is grounded for other reasons. Accordingly a great degree of flexibility is provided by the invention.

Referring to FIGS. 5-8, the elongate channel 5 is of sufficient depth, and width to house various types of electronic equipment to serve the passenger cabin such as the digital system entertainment boxes 7 (DSEB) shown as an example. These DSEB units 7 are existing or newly manufactured electronics that supply electric power, video on demand, audio on demand, internet connection and other services to a passenger seat. The channel 5 being an open longitudinal recess in the floor covered with a removable cover has the capacity to house relatively large bulky components at various longitudinal locations and can serve as a cable raceway for associated cables and harnesses.

Floor beams 2 extend transversely across the airframe, floor joists 3 extend longitudinally some of which include seat tracks 4 in their upper surfaces for anchoring seat legs 8. Floor panels 9 of generally standard length and width span between the co-planar top flanges of the floor beams 2 and the floor joists 3 and are connected with removable bolts 10. The floor panels 9 not only support loads applied by passenger traffic but act as a diaphragm to reinforce the floor beam 2 and joist 3 framework, and so removable bolts 10 together with the floor panels 9 transfer shear loads in the plane of the floor panels 9.

The channels 5 are defined by a pair of support brackets 11 that have an upper wall 12 adjacent an access opening 16 in the floor panel 9, side walls 13 and a bottom wall 14. As best seen in FIGS. 6-7, the brackets 11 hang from an underside of the floor panel 9 fastened with bolts 15. The upper walls 12 of the brackets 11 include laterally extending cover mounting tabs 17 which extend into the opening 16 and support the removable access cover 18. To locate the access cover 18 and to transfer the shear loading in the plane of the floor panels 9, as best seen in FIGS. 6-7, one of either the access cover 18 or the tabs 17 includes a shear pin 19 and the other then includes a matching shear pin receiving recess 20.

As seen in FIG. 8, the access cover 18 is preferably made of the portion of the floor panel 9 removed to create the opening 16 and fitted with latches 21. The latches 21 are shown in operation in a closed position (solid lines) and an open position (phantom lines) with adjustable end clamps 22 engaging an underside surface of the flange of the adjacent floor beams 2. In this manner, any existing floor panels 9 can be completely reused, the floor beams 2 and joists 3 need not be modified and the entire channel 5 structure is under-hung from the floor panels 9 reducing the need to obtain regulatory approval which is required for major structural modifications to aircraft.

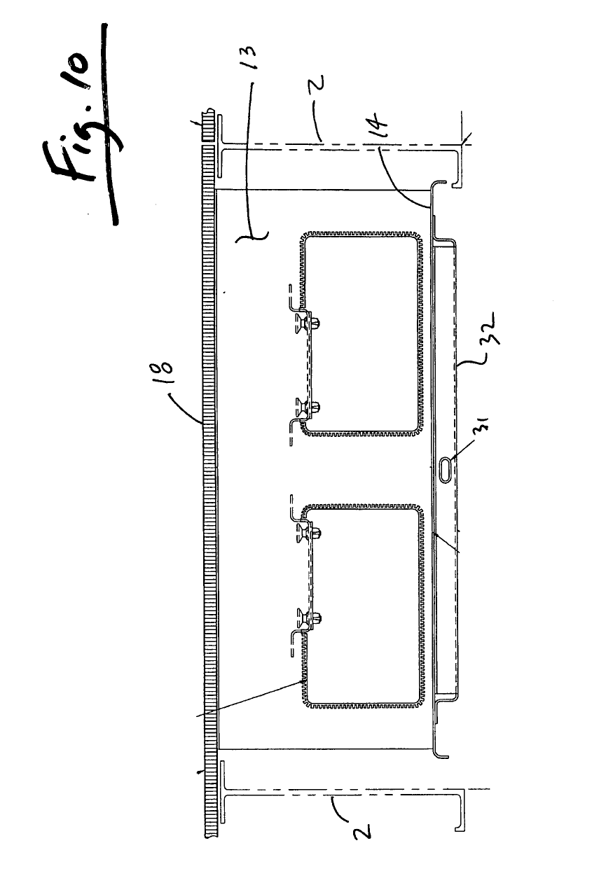

The bottom wall 14 of the brackets 11 includes equipment mounting fasteners 23 to secure the DSEB units 7 in position. As seen in FIG. 9, cabling 25 from the DSEB unit 7 to individual passenger seats 6 can be passed through cable mounts 24, then under the floor panels 9 and through a cable feed 26 having a sealed opening between the top and bottom surfaces of the floor panels 9 at required locations to proceed up the seat leg to a passenger interface unit.

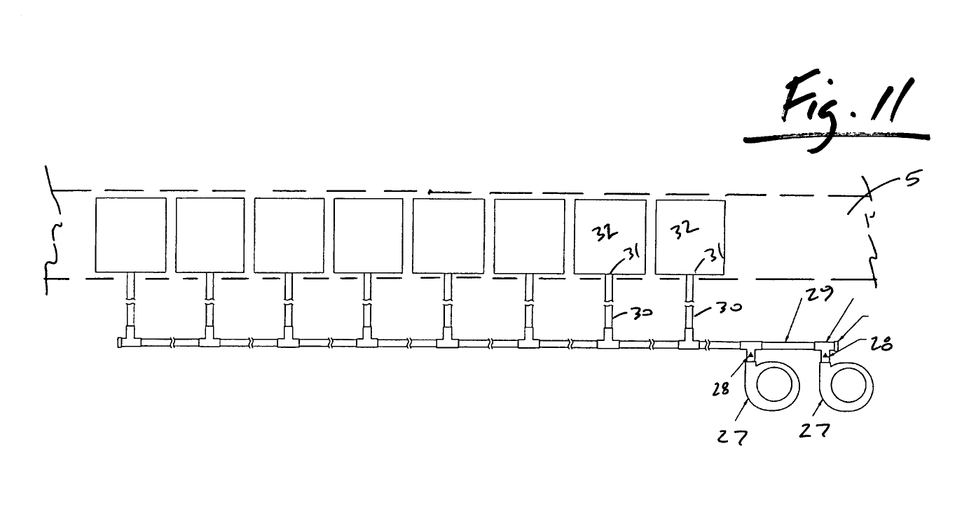

FIGS. 9-11 show the optional air cooling system which may be associated with the channel 5 to maintain the appropriate temperature for the electronic equipment and ensure optimal operation. Temperature sensors and fire suppression equipment may also be housed in the channel 5 since there is ample available space. A source of pressurized cooling air may comprise one or more air blowers 27 drawing ambient air and preferably with a one way check valve 28 between the blower 27 and the air distribution duct 29. The distribution duct 29 extends longitudinally and distributes air via a number of branch conduits 30 to the inlets 31 of cooling air plenums 32 at necessary locations. The bottom walls 14 of the brackets 11 forming the channel 5 optionally include a cooling air distributing plenum 32 which is perforated to distribute cooling air as required directed upwards towards the DSEB units 7. The air cooling system is very adaptable and easily modified to add or remove braches 30 or plenums 32 as required when equipment is modified. The use of a centralized blower system improves power consumption efficiency, reduces the number of small fans that need monitoring and maintenance, and eliminates a potential source of malfunctions.

From the foregoing description it will be appreciated that the invention provides a versatile under floor channel into which may be installed various types of equipment in an easily adaptable system.

Although the above description relates to a specific preferred embodiment as presently contemplated by the inventor, it will be understood that the invention in its broad aspect includes mechanical and functional equivalents of the elements described herein.

I claim:

1. An elongate channel for housing electronic equipment under the floor of an aircraft cabin, the floor having removable floor panels mounted with fasteners to flanges of transverse floor beams and longitudinal floor joists, the channel comprising:
a pair of support brackets having: an upper wall adapted for hanging from one said floor panel adjacent an opening therethrough; side walls; and a bottom wall;
a plurality of cover mounting tabs extending from the upper walls into the opening; and
an access cover removably mounted on the tabs.

2. An elongate channel according to claim 1 wherein at least one of the access cover and the mounting tabs includes a shear pin and a matching one of the mounting tabs and the access cover includes a shear pin receiving recess.

3. An elongate channel according to claim 1 wherein the access cover includes a latch.

4. An elongate channel according to claim 4 wherein the latch has an end clamp engaging an underside surface of the floor beam flange.

5. An elongate channel according to claim 1 wherein the bottom wall includes an equipment mounting fastener.

6. An elongate channel according to claim 1 wherein the side walls include cable mounts.

7. An elongate channel according to claim 1 wherein the bottom wall includes at least one cooling air inlet.

8. An elongate channel according to claim 7 wherein the bottom wall includes a cooling air plenum in communication with at least one said cooling air inlet.

9. An elongate channel according to claim 7 wherein the channel comprises a cooling air distribution duct having an inlet in communication with a source of pressurized cooling air and having a plurality of outlets in communication with a plurality of said cooling air inlets longitudinally spaced apart along a length of said channel.

10. An elongate channel according to claim 9 wherein the source of pressurized cooling air comprises at least one air blower.

11. An elongate channel according to claim 10 wherein the source of pressurized cooling air comprises a plurality of air blowers each having a check value disposed between the blower and the distribution duct.

12. A floor for an aircraft cabin, comprising:
a removable floor panel having an opening therethrough and fasteners for removably mounting to flanges of transverse floor beams and longitudinal floor joists;
a channel defined by a pair of support brackets having: an upper wall mounted to an underside of the floor panel adjacent the opening; side walls; and a bottom wall;
a plurality of cover mounting tabs extending from the upper walls into the opening; and
an access cover removably mounted on the tabs.

13. A floor according to claim 12 including a floor panel having cable feed through opening between a top and a bottom surface of the floor panel.
